(19) United States
(12) Patent Application Publication
(10) Pub. No.: US 2026/0319703 A1
(43) Pub. Date: Oct. 15, 2026

(54) BATCHING MEMORY COMMANDS VIA A GRID OF QUEUE PAIRS

(71) Applicant: Micron Technology, Inc., Boise, ID (US)

(72) Inventor: Pierre Labat, Campbell, CA (US)

(21) Appl. No.: 19/177,363

(22) Filed: Apr. 11, 2025

(51) Int. Cl. G06F 3/06

(52) U.S. Cl. CPC G06F 3/0659; G06F 3/0604; G06F 3/0679

(57) ABSTRACT

Systems, methods, and apparatus related to host system access to a memory sub-system. In one approach, a host system batches submitting of commands for processing by a solid-state drive via a same queue pair (submission queue and corresponding completion queue). The host system includes a graphics processing unit having multiple streaming multiprocessors. Each streaming multiprocessor is associated with multiple submission queues. The solid-state drive retrieves commands from each submission queue as a batch.

### TECHNICAL FIELD

At least some embodiments disclosed herein relate to memory systems in general, and more particularly, but not limited to batching of memory commands by a host system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a grid of queue pairs used by a host system to access a solid-state drive according to one embodiment.

FIG. 3 shows threads running on a host system that write commands into a submission queue according to one embodiment.

FIG. 4 shows threads that write commands in submission queues for accessing user data stored in a non-volatile memory cell array according to one embodiment.

FIG. 5 shows a method for batch processing of commands for input/output operations (IOs) using threads from a same warp according to one embodiment.

FIG. 6 shows a method for batch processing of commands for threads from different warps according to one embodiment.

FIG. 7 is a block diagram of an example computer system in which embodiments of the present disclosure can operate.

### DETAILED DESCRIPTION

At least some aspects of the present disclosure are directed to techniques for sending commands from a host system to a memory sub-system. The host system batches submitting of commands for processing by the memory sub-system via a same queue pair (submission queue and corresponding completion queue).

Existing approaches use only one queue pair for each streaming multiprocessor in a graphics processing unit (GPU). When many threads running on the streaming multiprocessor (SM) want to access the queue pair, this creates contention between the threads. The contention causes a need for synchronization of the threads, which causes inefficiency in operation of the GPU.

In some embodiments, instead of using a single large queue pair as an existing approaches, several smaller queue pairs are used for each streaming multiprocessor in a GPU. In one example, only a single warp of threads uses one of the smaller queue pairs. Because other warps cannot use this same queue pair, synchronization of processing by the threads of the warp can be done much more efficiently. The queue pair is shared by only the threads from a single warp, and commands are written by these threads to a submission queue of the assigned queue pair. Submission of the commands from the host system to the memory sub-system is synchronized so that the commands are processed in batches. The threads of the single warp are synchronized when doing IOs using the queue pair. In one example, when using a smaller queue pair, the submission queue is typically full during a time interval for a batch submission/ringing of doorbell register, with one or two commands from each thread in a warp.

Batching of commands for a same queue pair can provide various advantages. For example, power consumption of the GPU can be reduced, more GPU resources can be made available for other useful work instead of being idled by inefficiency due to thread contention, and efficiency can be improved in usage of the PCIe interface. For example, batching of commands can permit the PCIe interface to use aggregation bursts when sending commands to a memory sub-system.

Processing commands in batches as described herein can make better use of host system resources as compared to processing commands individually. Using several smaller queue pairs provides isolation of GPU threads. For example, a GPU functions more optimally when the GPU threads do not need synchronization between among each other to continue processing operations, or at most only need intra-warp synchronization, which is highly efficient as compared to thread synchronization between different warps. If external warp synchronization is needed, streaming multiprocessors work in a degraded mode in which the SMs can only run one thread per cycle while synchronizing. This degradation increases as the number of threads to synchronize increases.

In contrast, the threads processing IOs of a batch do not need any synchronization with other threads processing IOs of other batches. This isolation of thread processing can be achieved by organizing the IO interface into independent resource sets associated with each of the smaller queue pairs. The threads handling an IO batch for each small queue pair use a set of resources dedicated to that queue pair. This set of resources is not used by other threads working on other batches.

Although some IO latency may be introduced when waiting for a batch to fill, this situation is merely marginal in the context of a GPU initiating IOs. The GPU is significantly faster in generating commands than the SSD(s) is in executing those commands. Thus, there is typically a plethora of IOs waiting to be passed to the SSD(s). Consequently, when a batch is initiated, it is generally immediately filled. The rarer case may occur at the end of a workload when the last IOs are not a multiple of the batch size. However, any such delay introduced is minor relative to the significant general benefits of improved GPU throughput/IOPs/low power consumption.

A storage space in a memory sub-system is accessed by the host system using the commands sent via a submission queue. For example, the commands can specify read or write operations that access the storage space implemented using one or more non-volatile memory devices of the memory sub-system. The commands retrieved from the submission queue can be loaded to an internal command queue of the memory sub-system for a controller to execute the commands, including parsing the commands to identify the parameters and options or requirements related to the performing of the read or write operations in the storage space.

The commands sent from the host system can be configured in various ways. In some embodiments, each command is constructed according to a standard of NVMe to have predefined fields and a common total size (e.g., 64 bytes used for each command). In some embodiments, an indication is included in each command to indicate a type of operations to be performed by the memory sub-system during execution of the command. In some embodiments, the commands each have a same total size (e.g., 64 bytes) according to an NVMe standard. For example, a command having 64 bytes can be seen as bit segments arranged as Dwords (double words) 0-15.

A conventional memory sub-system (e.g., a solid-state drive in compliance with a non-volatile memory express (NVMe) standard) can include a flash memory (e.g., NAND memory) that is to be in an erased state before being programmed to store data. For example, such a flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

A conventional host system is configured (e.g., according to an NVMe standard) to instruct the memory sub-system to store data at locations specified via logical block addresses (e.g., LBA addresses). Each logical block address identifies a block of storage space that can be implemented using the storage capacity of one or more pages of memory cells. For example, a typical size of the storage space represented by a logical block address in a solid-state drive (SSD) is 512 bytes (or larger, e.g., 4 KB). The memory sub-system (e.g., SSD) can have a flash translation layer configured to map the logical block addresses as known to the host system to physical addresses of memory cells in the memory sub-system. As a result, the host system does not have to be aware which data items are stored in which particular memory cells.

A conventional NVMe solid-state drive (SSD) can receive commands from a host system via a submission queue and provide completion records about execution of the commands in a completion queue (sometimes referred to as a queue pair (QP)). The host can write to a doorbell register in the SSD to cause the SSD to poll submission queues for commands.

In a typical NVMe implementation, processors (e.g., CPU, GPU, AI accelerators) communicate over a PCIe bus with an SSD via random access memory/main memory of the host system of the SSD. For example, a pair of message queues in the memory can be used for a processor to send commands to the SSD in the submission queue, and for the SSD to send completion records to the processor in the completion queue.

Each submission queue is a circular queue having slots of the same size. Each slot in a submission queue holds one command for execution by the SSD. Each slot in the completion queue holds a completion record about the execution of a command.

For example, when a submission queue is configured in the host memory outside of the SSD and when a processor enters a command in a submission queue configured in the main memory, all related activity occurs within the host system (e.g., the processor and its main memory/random access memory). The SSD is not aware that the processor has entered the command in the submission queue. The SSD may periodically read the submission queue to determine if there are new commands in the submission queue. Alternatively, that SSD may have a doorbell register; and the processor can write to the doorbell register to cause the SSD to check the submission queue.

In the NVMe standard, the SSD typically reads/writes data in blocks of 512 bytes or more (4 KB is recommended). The NVMe protocol implements certain features for communications between processors and the SSD using access to random access memory. An NVMe command can include various information about operations to be performed (e.g., read or write), a location in a storage space in the SSD for performing the operation, a location in the main memory to store the retrieved data for a read, or a location in the main memory to retrieve the data to be written into the SSD.

With the advent of artificial intelligence (AI), the set of various requirements for storage have become more uncertain as many parts of the AI pipeline now require significantly different IO profiles from prior profiles used for the storage stack. For example, the entire preparation process for data processing can bring large amounts of data close to where the AI training nodes are located. This increases SSD capacity. In a similar way, both AI training and inference nodes can use faster SSDs placed in close proximity to the GPU clusters (or even inside the clusters, in some cases). This creates a new set of requirements for SSDs. To meet these challenges, significant changes can be made in how the CPU/GPU communicates to the storage devices (e.g., SSD in this case).

Within a class of applications (e.g., using CPU/GPU attached SSD to address both AI training and inference needs), there are two areas needing improvement: parallelism and command delivery.

Regarding parallelism, the threading level of a GPU can be massive and use many SSD queue pairs (QPs), as they are the means to convey thread data to the SSD. For example, current SSDs support up to 2K queues, but a typical GPU can have tens of thousands of threads to match. Enqueueing/dequeuing at an N: 1 ratio is resource expensive as each insert/remove requires the thread to arbitrate for a lock, acquire the lock, add/remove the entry, release the lock, and then repeat, thus wasting valuable resources and time. The foregoing situation creates the need for the SSD to support a larger number of QPs or potentially even an interface not using QPs (or in a different form from that defined in the NVMe specification).

Regarding command delivery, the NVMe protocol uses a queuing system that is fast but was not designed for the above scale of operation. Even though the queuing system is flexible and widely adopted, there is a need for an improved queue delivery mechanism.

In addition to the above, there are other technical challenges associated with NVMe devices. As SSDs have increased in speed, more recent systems use an SSD as secondary memory in AI applications. For example, many GPU cores/threads may have parallel requests to the SSD for such applications. It can be advantageous to use one queue pair (a pair of submission queue and completion queue) for each thread. However, AI applications in some cases can have a very large number of parallel threads (e.g., hundreds of thousands or more). But, for example, a typical SSD is limited to handling only 1024 submission queues (e.g., because of the hardware/controller used in the SSD). As a result, the host needs to run software to combine commands from multiple threads into a single submission queue. This can cause inefficiencies due to synchronization required for handling the combination of commands from these threads.

In one example, an NVMe interface is used for communication between a GPU or other host on one side of a connection fabric (e.g., PCIe fabric) and an NVMe SSD on the other side of the connection fabric. This interface is used by the GPU or host to send NVMe commands to the SSD and to receive NVMe command completions.

For example, the NVMe interface passes NVMe commands and gets completions as described in NVMe spec 2.0. This interface uses NVMe Submission Queues, Completion Queues, and NVMe doorbells. This interface was designed for use cases in which the number of threads is fairly limited. However, as mentioned above, new use cases having large numbers of threads are emerging for which this interface is not efficient. Thus, there is a need for an improved NVMe interface to cope more efficiently with these new use cases.

In one example of a NVMe use case, threads running in a host operating system (OS) issue NVMe commands. These OS threads (e.g., several thousands of threads) are factored on host logical CPUs (sometimes referred to herein as LCPUs) with one queue pair (QP) associated to each logical CPU. This is done because OS threads are scheduled one at a time on an LCPU.

Even if there are thousands or more OS threads doing input/output operations (IOs) on a host server, only a few hundred (number of host LCPUs) actually access QPs at the same time. This limitation exists because at any given time, only one thread can run on a given LCPU.

Because the QP associated to the LCPU is updated by one thread at a time (the one currently running on the LCPU), there is no need for synchronization between threads regarding QP updates. However, the QP update is typically enclosed by synchronization code to handle the rare situation of one or more LCPUs being removed. This synchronization code doesn't generate significant overhead.

The synchronization is typically implemented via an atomic variable, one per QP. A test-and-set operation is done on that atomic variable. For example, the atomic variable AVi for QPi stays in the L1 cache of LCPUi associated to QPi. A thread running on LCPUj accesses only AVj and never AVi. Consequently, the atomic variable stays exclusive in the L1 cache, and modifying the atomic variable requires about one clock cycle.

An NVMe Completion Queue of a QP is polled by only one thread at a time, running on the LCPU associated to the QP. Hence, the most likely situation for the submission queue (SQ) is that there is no need of synchronization. For this use case, the NVMe interface typically operates satisfactorily.

However, as mentioned above, there are new emerging NVMe use cases in which a processor (e.g., a GPU) issues a large number of NVMe commands. For example, in these use cases hundreds of thousands of GPU threads can access the NVMe QPs simultaneously. This is significantly more than the number of threads for the few hundreds of LCPUs of the use case above.

The thread synchronization required above presents a technical problem that induces significant GPU overhead when queuing NVMe commands and getting their completion status. This overhead is incurred by the threads on the GPU when the threads synchronize the access to NVMe submission queues (SQs) and completion queues (CQs). Implementing this synchronization code robs processing cycles and/or resources from the GPU (e.g., a Streaming Multiprocessor (SM) of the GPU).

Now discussing this increased overhead need in more detail, on an NVIDIA GPU, for example, threads run on Streaming Multiprocessors. A GPU contains typically between one and two hundred SMs. Each SM can run several thousands of threads in parallel.

Similarly to the NVMe use case above, it can be desirable to have only one thread at a time using a QP. In such case, there could be a need, for example, for several hundred thousand NVMe QPs. Each QP would have one or very few NVMe commands (and most of the time typically only one command) queued in the QP submission queue. The creation of these QPs would be time-consuming, and these QPs would waste a lot of SSD hardware resources.

Having a limited number of NVMe QPs available, one can consider how the use of the QPs might potentially be optimized in the above GPU use case. Noting that all threads running on a same Streaming Multiprocessor (SM) share the same L1 cache, an efficient use of NVMe QPs is to use one QP per SM. Any thread running on the SM can use the QP associated to the SM. Doing so guarantees that the serialization atomic variables (e.g., used to serialize access to the QP across threads running in parallel on the SM, one set of atomic variables per QP) and the QP itself stays in the SM L1 cache. No other thread running on another SM is going to access the QP.

When contention happens (e.g., several threads running on the same SM post in the SQ or read the CQ), the contention is handled in the SM L1 cache, and there is no need to access the GPU main memory. This reduces SM thread stalls (e.g., cache miss is avoided) by handling the contention in L1 cache, and also reduces the usage of memory bandwidth.

However, the above approach still has significant limitations. Specifically, the threads running on a same SM must wait in turn to access the QP, one after the other. The threads wait by looping doing atomic operations on the QP atomic variables, to know when it is a thread's turn to access the QP. This creates undesirable SM overhead. Also, when one thread is accessing an atomic variable, no other thread can run on the same SM. In contrast, a warp (32) of threads can be running simultaneously on the SM.

In some approaches, a part of the queueing can be done in the same SQ in parallel (e.g., writing NVMe commands in parallel in different entries of the SQ). But these approaches themselves also require the use of atomic variables. Some parts of the queuing cannot be done in parallel. For example, the SQ doorbell update and ensuring that SQ content is consistent with the doorbell value must still be serialized. For completion queues (CQs), memory atomic operations are used again to synchronize several SM threads reading the CQ associated to the SM.

Thus, even if attempts were made to improve queuing by assigning QP(s) per SM (e.g., atomic memory variables used for synchronization stay in L1, and contention is reduced to intra SM) and writing is done in parallel in SQ entries, there is still undesirable overhead having the SM use atomic memory operations (e.g., in particular at high frequencies).

At least some techniques provided in the present disclosure address the above and other deficiencies and challenges by batching commands associated with a same queue pair. The size of the batch is the size of the queue pair (QP). A batch of commands is all commands that are written to a submission queue (SQ) of the queue pair. For example, a batch has 32 commands each entered by a respective thread of a warp.

A submission queue is seen by the memory sub-system (e.g., SSD) as being either full or empty. For example, when the submission queue is filled with 32 commands, the host system writes an indication to the doorbell register of the memory sub-system.

The host system handles a batch of commands as a unit. For example, the GPU considers the commands to be completed only after all the commands in the batch have completed. For example, in a batch of 32 commands, 31 commands may have completed execution, but the GPU is waiting for the final command to complete execution.

In one embodiment, implementation of command batching does not require any hardware or software change on the SSD. Also, no hardware change is required on the GPU. Software changes are made in cache management software and/or SCADA server code to implement the command batching. Communications between the GPU and the SSD can use PCIe interface spec 2.0. In addition, optional configuration of the SSD can be made to improve performance. For example, an arbitration burst associated with the SSD can be set to the size of the queue pair.

The host system notifies the memory sub-system that a batch of commands is available in the submission queue by writing a value (e.g., the number 32, which corresponds to the number of commands in the batch) to a doorbell register of the memory sub-system. The SQ is associated with a doorbell register in SSD memory (e.g., using a BAR). In response receiving the value, the controller of the memory sub-system retrieves the commands from the submission queue. After executing each retrieved command, the controller generates a completion record. The completion records are sent to the completion queue.

In one example, configurations of the commands written to the submission queue by each thread are in accordance with a current standard of NVMe (e.g., NVM Express NVM Command Set Specification, Revision 1.1 of Aug. 5, 2024; and NVM Express Base Specification, Revision 2.1 of Aug. 5, 2024, the contents of which are hereby incorporated herein by reference).

In one example, a GPU accesses a solid-state drive using a queue pair. Commands generated by threads of the GPU are in accordance with the existing NVMe standard. Completion records generated by the SSD are in accordance with the existing NVMe standard.

In one example, a portion of GPU memory is allocated for providing buffers to store the queue pairs (submission queue and completion queue). In one example, software executing on the GPU (e.g., GPU configuration code) allocates the queue pair buffers (for each pair of SQ and CQ) and then communicates with an SSD. The SSD receives the SQ address and CQ address from the GPU.

In one example, a processor (e.g., GPU) generates commands retrieved by an SSD from the submission queue over a PCIe bus. For example, the processor can be a GPU Streaming Multiprocessor (e.g., NVIDIA GPU), a host core, or other similar physical processing unit running code that issues NVMe commands.

In one embodiment, a memory sub-system stores data in non-volatile memory cells. A controller of an SSD receives access commands. In response to receiving each access command, the controller executes the corresponding access command to perform an operation on the non-volatile memory cells.

In one embodiment, an SSD includes at least one non-volatile memory device and one or more controllers. The SSD stores data for a host system on which a plurality of threads execute for training a neural network(s). One or more of the threads are each assigned for reading a page of data into a slot of a cache (e.g., a software cache in GPU memory).

In one embodiment, a memory sub-system (e.g., an SSD) is configured to provide access to a host system. The host system can read/write the SSD using an NVMe block command set based on addressing in a block namespace, where the full LBA block of data is transmitted across the PCIe bus for read or write.

In one example, a read and write can be performed using an NVMe memory namespace command set. An SSD can be configured to perform a read operation to retrieve the data from a set of memory cells allocated as the storage resources of an LBA block.

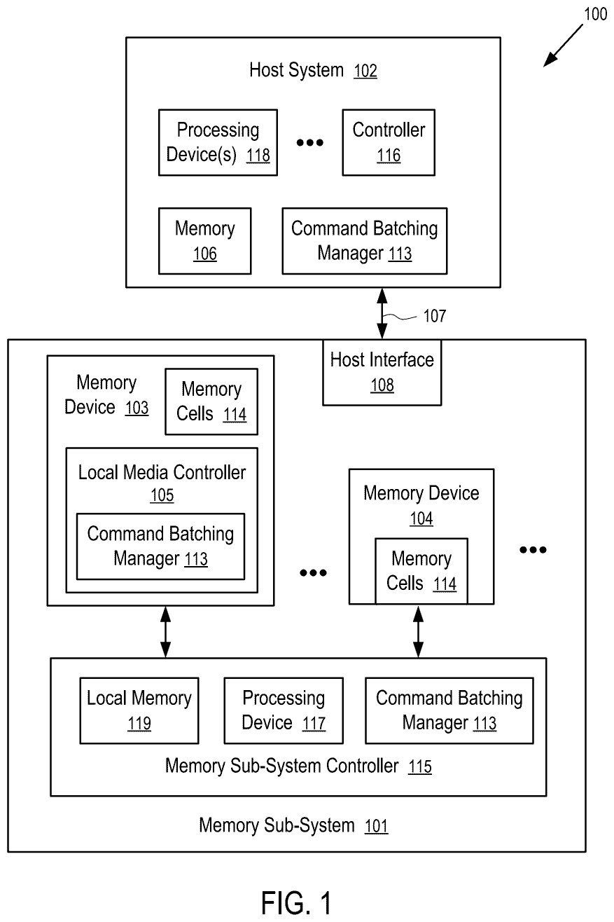

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include command batching manager 113 configured to manage batching of commands used to access memory sub-system 101. For example, command batching manager 113 of controller 115 retrieves access commands from a submission queue located in memory 106. For example, command batching manager 113 of host system 102 manages synchronization of threads in a batch used for writing the access commands into the submission queue. In various embodiments, the command batching manager 113 is used to exchange input/output (IO) commands and completions between a host system (e.g., a GPU) and a memory sub-system (e.g., an SSD).

In some embodiments, the controller 115 in the memory sub-system 101 includes at least a portion of the command batching manager 113. In other embodiments, or in combination, the controller 116 and/or the processing device 118 in the host system 102 includes at least a portion of the command batching manager 113. For example, the controller 115, the controller 116, and/or the processing device 118 can include logic circuitry implementing the command batching manager 113. For example, the controller 115, or the processing device 118 (processor) of the host system 102, can be configured to execute instructions stored in memory for performing the operations of the command batching manager 113 described herein. In some embodiments, the command batching manager 113 is implemented in an integrated circuit chip disposed in the memory sub-system 101. In other embodiments, the command batching manager 113 can be part of firmware of the memory sub-system 101, an operating system of the host system 102, a device driver, or an application, or any combination therein.

For example, the command batching manager 113 implemented in the controller 115 and/or 105 of the memory sub-system 101 can manage writing a batch of commands to slots of a submission queue, writing a value to an SQ doorbell register of memory sub-system 101, and writing completion records to slots of a completion queue. Host system 102 sends commands to the memory sub-system 101 over a PCIe fabric. Controller 115 executes the commands (e.g., NVMe commands) to access memory device 103.

In one example, the controller 115 can run the command batching manager 113 of the memory sub-system 101 to retrieve commands from the host system 102 over a PCIe fabric. Controller 115 executes the commands (e.g., NVMe commands) to access memory device 103. Controller 115 indicates completion of the commands to host system 102 by sending signals over the PCIe fabric.

In one example, managers in the host system 102 and in the memory sub-system 101 are configured to establish namespaces. For example, the namespace can be an NVMe block namespace. The smallest unit of storage space accessible in the namespace is a block represented by a respective address defined in the namespace to represent the block. For example, the storage size of a block can be 512 bytes or more (e.g., 4096 bytes). A set of physical storage resources (e.g., memory cells 114) are allocated to implement the physical storage space represented by the namespace.

In one example, memory sub-system 101 is configured to access a region of storage locations. Host system 102 can use a protocol (e.g., a NVMe block command set) to send an access request to an SSD. The access request is directed to an address in a namespace; and the memory sub-system 101 can provide a corresponding response using the protocol.

For example, the access request sent to the SSD can be a read command. The memory sub-system 101 can execute the read command and determine the storage resource allocated to implement a logical block having the address defined in the namespace. The memory sub-system 101 then retrieves a data block from the storage resource, and sends the data block across the computer bus 107 to the memory 106 of the host system 102, as instructed by the access request according to the protocol.

For example, the access request sent to the SSD can be a write command. The memory sub-system 101 can use an address map to determine a storage resource block allocated to implement a logical block having the address defined in the namespace. After retrieving the data block from the memory 106 of the host system 102, as instructed by the access request according to the protocol, the memory sub-system 101 can program the storage resource block to store the data block obtained from the memory 106 of the host system 102.

Further details of the operations of the command batching manager 113 in the host system 102 and in the memory sub-system 101 are discussed below.

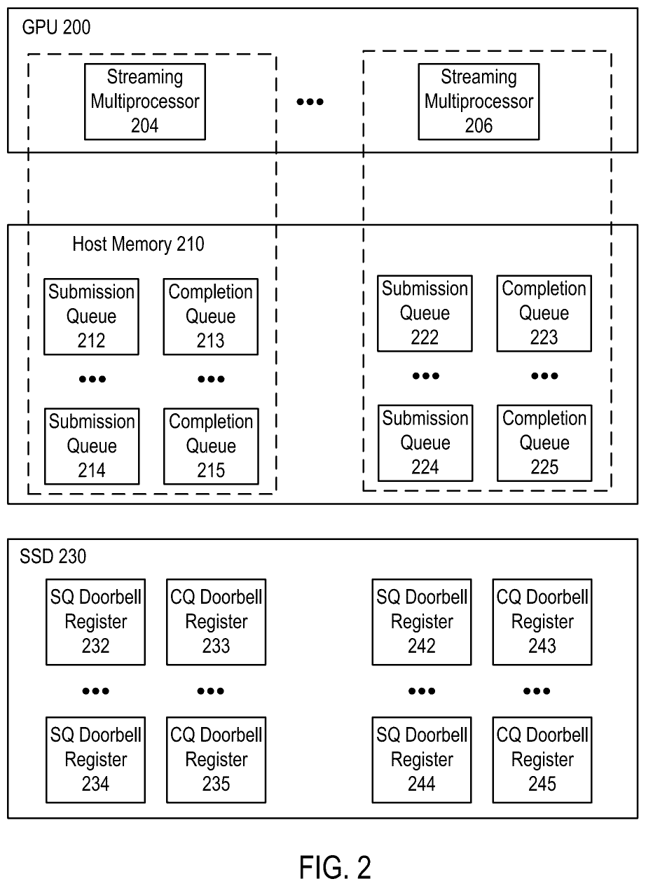

FIG. 2 shows a grid of queue pairs used by a host system to access a solid-state drive 230 according to one embodiment. GPU 200 includes several streaming multiprocessors 204, 206. GPU 200 is an example of processing device 118, and SSD 230 is an example of memory sub-system 101.

Each streaming multiprocessor is associated with multiple queue pairs in host memory 210. For example, streaming multiprocessor 204 is associated with a queue pair including submission queue 212 and completion queue 213. Streaming multiprocessor 206 is associated with a queue pair including submission queue 224 and completion queue 225.

Each queue pair is associated with a pair of doorbell registers in SSD 230. For example, submission queue 212 corresponds to submission queue doorbell register 232. Completion queue 213 corresponds to a completion queue doorbell register 233. Similarly, submission queue 224 corresponds to SQ doorbell register 244, and completion queue 225 corresponds to CQ doorbell register 245.

Various threads are running on streaming multiprocessor 204. These threads write commands into slots of submission queues 212, 214. Similarly, threads running on streaming multiprocessor 206 write commands into slots of submission queues 222, 224. GPU 200 manages assignment of queue pairs to these threads so that commands are batched.

When a value is written into one of SQ doorbell registers 232, 234, 242, 244, SSD 230 retrieves a batch commands from the corresponding submission queue 212, 214, 222, 224. After each command is executed, SSD 230 generates a completion record. SSD 230 writes the completion records to the corresponding one of the completion queues 213, 215, 223, 225.

When one of the completion queues has received a full batch of commands (e.g., 32 completion records are received), and this is determined by one of the threads running in the corresponding streaming multiprocessor, then GPU 200 writes a value into a corresponding one of CQ doorbell registers 233, 235, 243, 245. The value corresponds to a number of commands in the batch, which is equal to the number of completion records received. In one example, the value is 32, which corresponds to a number of threads in a single warp using a small queue pair of submission queue 214 and completion queue 215.

In one embodiment, each submission queue 212, 214, 222, 224 is assigned a submission queue identifier (SQ ID). SSD 230 retrieves commands from each submission queue in an order that corresponds to the submission queue or queue pair identifier. For example, SSD 230 uses a round-robin approach for retrieving the commands. In one example of a round-robin approach, an SSD first processes one submission queue for each streaming multiple processor (e.g., the first row of submission queues 212 to 222 in the grid). After serving one submission queue for each streaming multiprocessor, the SSD serves a different submission queue for each streaming multiprocessor (e.g., the second row of submission queues 214 to 224 in the grid). This process repeats until each row of submission queues is served once, and then the SSD can repeat the servicing of the entire grid of submission queues.

When SSD 230 retrieves commands for a given queue pair, SSD 230 can do an aggregation burst to retrieve all commands in a batch from the submission queue. Then, the SSD 230 moves to the next queue pair to fetch additional commands, and repeats this for the remaining queue pairs that have been created in host memory 210 by GPU 200 and associated with SSD 230.

The size of the QP is the batch size. For example, the queue pair has a size of 32 entries. It is desirable to use smaller queue pairs so that command latency is not increased as seen by the GPU 200. The GPU 200 considers a command completed only when all the commands in the QP have completed.

In one example, the number of threads in a warp is limited to 32. Thus, there is no benefit on the GPU side to use a size of the queue pair that is larger than 32. Thus, the maximum QP size should be 32.

In one example, for the use case of a SCADA server (but that does not use a software cache implementing an array abstraction), 32 should be an optimal batch size. This is so because all 32 threads of a warp are each doing a different IO in lock step.

In one example, GPU 200 uses a software cache to implement an array abstraction in host memory. In this case, the threads initiating IOs are most likely from different warps. Typically, only one thread of a warp does an IO. Thus, size of the batch can be made less than 32.

The number of queue pairs used for each streaming multiprocessor can vary. For example, the number of QPs per SM selected should be sufficient to allow the maximum IOPs desired from the SSD.

In one example, two queue pairs per SM are used. A number of simultaneous IOs can be computed as 2×(32 IOs per QP)×108 SMs=6912 IOs in flight. In one example, an SSD can process only 1024 IOs simultaneously. Consider in one example that on each SM one batch of IOs is being assembled and the other batch of IOs is in flight. In this case, there would be 3456 IOs in flight to the SSD.

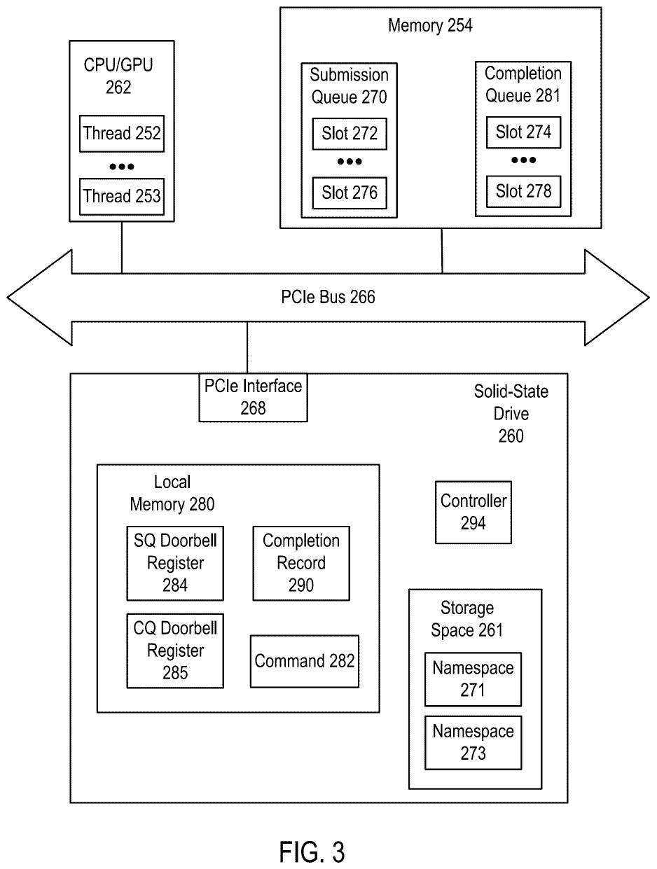

FIG. 3 shows threads 252, 253 running on a host system that write commands into a submission queue 270 according to one embodiment. Controller 294 of solid-state drive 260 retrieves the commands 282 from submission queue 270 and then executes the commands 282. Solid-state drive 260 is an example of memory sub-system 101. GPU 262 is an example of GPU 200.

Threads 252, 253 write commands into submission queue 270 in parallel. Each thread writes a command 282 (e.g., read/write command) into a different slot 272, 276. Once all commands 282 in a batch have been written to submission queue 270, then a value is written in SQ tail doorbell register 284. The value corresponds to the number of entries in the batch. Controller 294 retrieves command 282 in response to receiving the value in doorbell register 284.

As each command 282 is executed, controller 294 generates completion record 290. Controller 294 causes completion record 290 to be written to completion queue 281. Each completion record is written to one of slots 274, 278.

Each of threads 252, 253 polls a corresponding slot 274, 278 in parallel to determine completion of execution of commands 282. Once all commands in a batch have been executed, a value is written in completion queue head doorbell register 285. The value corresponds to the size of the batch (e.g., 32).

CPU/GPU 262 communicates with memory 254 and solid-state drive 260 using PCIe bus 266. Memory 254 has a submission queue 270 for holding commands (e.g., NVMe read or write commands 282) to be retrieved by the solid-state drive 260. CPU/GPU 262 generates the commands and places each command into one of slots 272, 276 of submission queue 270. CPU/GPU 262 and memory 254 are an example of host system 102.

In one embodiment, CPU/GPU 262 assigns an index to each thread running on CPU/GPU 262 that will perform an IO operation. Each index identifies and corresponds to a pair of slots in memory 254. Specifically, the index identifies slot 272 of submission queue 270 and slot 274 of completion queue 281. The indexes are used by CPU/GPU 262 and solid-state drive 260 for accessing slots in submission queue 270 and completion queue 281.

The retrieved command 282 is temporarily stored in local memory 280 until executed by controller 294. After command 282 has been executed, controller 294 generates completion. For example, controller 294 writes completion record 290 to slot 274 of completion queue 281. Thread 252 polls slot 274 and determines one of the commands 282 in the batch has been executed based on the completion record 290 being written in slot 274. In one example, thread 252 determines completion based on a value of a phase bit in completion record 290.

Solid-state drive 260 retrieves the commands from the submission queue 270 via PCIe interface 268. The retrieved commands are buffered in the local memory 280 of the solid-state drive 260. In one example, memory 280 is a command queue of solid-state drive 260. In one example, memory 280 is buffer memory or local random access memory for temporary storing of commands waiting to be processed/executed.

In some embodiments, each command 282 has a common size in bytes. In one example, the data structure of the command 282 corresponds to a command structure defined in a current version of the NVMe standard; and each field in the command 282 corresponds to a predefined location (e.g., bit segments) in the command to provide a parameter in a way defined in the NVMe standard.

Each command 282 includes an indication of a type of processing to be performed by controller 294 when executing the command. The indication indicates how each field of the command is to be processed. For example, the field is a data pointer or starting LBA address. For example, the field is Dword 13 of an NVMe read command containing parameters/options (e.g., for Dataset Management and/or other parameters).

In one example, SSD 260 has a DMA engine (not shown) to retrieve data/commands from the memory 254 and write data/completion records to the memory 254. The data in a slot in a submission queue 270 (e.g., as configured according to the NVMe standard) is seen by the solid-state drive 260 as a command. The controller/processor 294 of the SSD checks various segments/fields of the data/command to determine what operations/tasks the CPU/GPU 262 wants the SSD to perform by entering the command/data in the slot 272, 276.

In some embodiments, command 282 is configured in accordance with a current version of NVMe standard. Each command 282 has a total size of 64 bytes, or 16 Dwords (double words), that can be referenced as Dword 0 to Dword 15. When Dword 0 has the opcode value for a read as defined in a current NVMe standard, the command is interpreted as a read command; when the Dword 0 has the opcode value for a write as defined in a current NVMe standard, the command is interpreted as a write command.

SSD 260 includes storage space 261. For example, the storage space can be implemented via NAND flash memory. A read/write command is executed in the SSD 260 to read data from, or write data into, storage space 261.

The capacity of the storage space 261 can be partitioned into one or more namespaces 271, 273. Physical storage resources (e.g., NAND flash memory) are allocated to implement logical storage blocks in namespaces 271, 273. A namespace 271 or 273 can have a plurality of logical storage blocks, each having a same size and represented by a logical block addressing (LBA) address configured in the respective namespace 271 or 273. For example, to specify a location in the storage space 261, a fast or normal read/write command can specify a namespace identifier in a “namespace identifier” field configured in the respective command (e.g., Dword 1 or bytes 7:4 of the command), and an LBA address in a “Starting LBA (SLBA)” field in the respective command (e.g., in Dwords 10-11 or bytes 47:40 of the command), where the LBA address is defined specifically in the namespace represented by the namespace identifier.

In one embodiment, an index is assigned to a GPU thread 252 that is doing an IO. The corresponding slot 272 in SQ 270 and slot 274 in the CQ are at the same index in both arrays. The slot assigned to the GPU thread 252 is used only by that thread (for the time of the IO).

In one example, a GPU thread 253 writes NVMe command 282 in its assigned slot (e.g., slot index 3) in the SQ 270. Next, the GPU thread 253 determines that a full batch of commands has been written to submission queue 270 and writes a value in doorbell register 284 using a transaction layer packet over PCIe bus 266. An application specific integrated circuit (ASIC) in SSD 260 processes the TLP as it arrives to the doorbell register 284. Controller 294 retrieves all commands 282 in the batch from submission queue 270.

The SSD 260 processes the retrieved commands 282 (e.g., processes the command as defined in NVMe spec 2.0). After each command 282 is executed, the SSD 260 can write a completion record 290 in the CQ 281. In one embodiment, SSD 260 waits until all commands are executed before sending a full batch of completion records 290 to completion queue 281. For example, GPU thread 253 is polling slot 278 and notices the phase bit of completion record 290 has changed. Thread 253 determines this to be a completion of execution for one of commands 282. CPU/GPU 262 maintains an increasing count of the number of commands that have been executed. When the counter reaches the size of the batch, CPU/GPU 262 determines that all commands have been executed.

In one embodiment, a queue pair is allocated to a software cache implemented in memory 254. Each thread 252, 253 is assigned an index for performing IO. Threads 252, 253 read pages of data from a memory sub-system (e.g., SSD 260). Each page of the cache is stored in a slot that is identified by an index.

In one example, thread 252 writes a page of data from the cache to storage space 261 (e.g., to evict a dirty page). The page is written by thread 252 writing a write command 282 into slot 272.

In one example, GPU 262 or a controller of a memory sub-system can use a slot index to determine the memory address of the slot in the submission queue. The memory address of the slot is computed using a base address of the submission queue, and then adding an offset from the base address computed using the index multiplied by a common size of the slots in the submission queue. The memory address of a slot in the completion queue can be computed similarly.

In one example, the number of corresponding slots in one or more submission queues 270 and completion queues 281 is equal to the number of slots in the software cache. These one or more queue pairs are used to service functions of the cache. For example, threads doing IO at any given time are limited to using a maximum of one thread per cache slot. Each of the threads can only perform a single IO at any given time. The thread initiates the IO and then polls the slot identified by the index in the completion queue 281 for completion before performing other actions. As a result, each thread has its own dedicated slot or entry in the queue pair at position given by the index assigned to the thread (QP[index]). The QP index corresponds to the cache slot in which the thread loads a page (the thread reading in or flushing dirty data for the cache slot “i” uses QP[i]).

In one example, a software cache is used. Any IO is done in the context of reading a page into a cache slot or flushing a dirty page when evicted. Cache management software selects one unique GPU thread to do each read or write. For example, consider that that a read or write needs to be performed for cache slot i. The GPU thread in charge of doing the read or write in/from the slot i uses QP[i] to perform that operation. Any other GPU thread that happens to be doing IOs at the same time does IOs on other, different cache slots (e.g., slots j and k). The GPU thread doing an IO for the slot j uses QP[j], and the thread doing an IO on slot k uses QP[k]. Thus, when the GPU thread in charge of updating the cache slot i uses QP[i] for that operation, no other thread will be using QP[i].

The cache management software ensures that only one thread handles the reading of data into one cache slot or flushing the slot. Each cache slot is assigned one QP[] element.

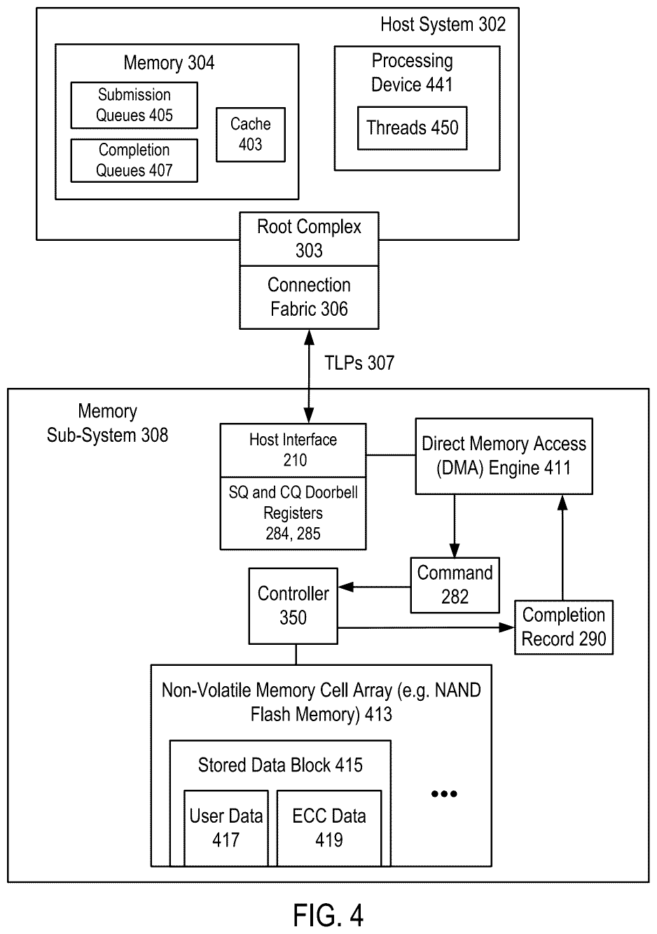

FIG. 4 shows threads 450 that write commands in submission queues 405 for accessing user data 417 stored in non-volatile memory cell array 413 according to one embodiment. Memory sub-system 308 includes submission queue doorbell registers 284 and completion queue doorbell registers 285. When a batch of commands is written to one of the submission queues 405, host system 302 writes a value to SQ doorbell register 284. In response to receiving the value, controller 350 retrieves the batch of commands 282 from the one submission queue 405. Controller 350 and/or direct memory access (DMA) engine 411 compute a memory address in the submission queue 405 using a base address of submission queue 405, the size of the slots in submission queue 405, and the value (e.g., the number 32). DMA engine 411 fetches the commands from the computed memory addresses for the slots.

Commands 282 retrieved from submission queue 405 are transferred from host system 302 using transaction layer packets 307. Host interface 210 receives TLPs 307 from connection fabric 306.

In response to receiving each command 282, controller 350 executes the command 282 to access non-volatile memory cell array 413. In one example, command 282 is a read command; and user data 417 and ECC data 419 are read from stored data block 415. ECC data 419 is used to correct any errors found in user data 417. DMA engine 411 transfers the read user data 417 to a memory location identified by a data pointer of command 282.

In one example, command 282 is a write command; and user data 417 and ECC data 419 are written to stored data block 415. DMA engine 411 transfers the user data 417 to be written from a memory location identified by a data pointer of the write command 282.

After execution of each command 282 in a batch is completed, controller 350 generates completion record 290. Completion records 290 are transferred by DMA engine 411 to slots of completion queue 407.

Memory sub-system 308 is an example of memory sub-system 101. Host system 302 is an example of host system 102. Host system 302 and memory sub-system 308 communicate over connection fabric 306. In one example, connection fabric 306 is a PCIe fabric. Connection fabric 306 includes a root complex 303. For example, root complex 303 can be implemented by hardware of host system 302, or can be implemented on a separate chip.

In one example, memory 304 is main memory of host system 302. In one example, when instructed by controller 350, direct memory access (DMA) operations on memory 304 are performed by DMA engine 411 according to various commands received from host system 302.

In one embodiment, host system 302 sends values to doorbell register 284 or commands to local memory of memory sub-system 308 using transaction layer packets 307 (e.g., TLPs according to a PCIe protocol).

In one embodiment, an ASIC receives a transaction layer packet(s) written to the address of the doorbell register 284 or other portion of local memory. The root complex 303 of the connection fabric 306 commits each TLP aligned on a boundary having a fixed size in bytes. Each TLP has a data payload that is equal to or a multiple of the fixed size. The data payload includes, for example, a command written to submission queue 405 by a thread 450 executing on processing device 441. In one embodiment, multiple commands in a batch (e.g., 32 commands) can be delivered to the memory sub-system using a single transaction layer packet.

In one embodiment, one or more threads 450 write commands 282 to slots in submission queue 405. When executed in the memory sub-system 308, the commands cause pages of data to be written to or read from cache 403. In one example, DMA engine 411 transfers user data 417 from stored data block 415 to cache 403 in response to retrieving a read command 282. In one example, processing device 441 flushes a page of dirty data from cache 403 for the memory sub-system 308 to store as data block 415.

In one embodiment, cache 403 is used by a thread 450 to perform operations. For example, cache 403 is high bandwidth memory (HBM). For example, cache 403 is a software cache of a GPU.

One or more queue pairs are allocated to cache 403 by processing device 441. Each queue pair includes a submission queue 405 and a completion queue 407. Each slot of cache 403 is associated with a slot of submission queue 405 and a corresponding slot of completion queue 407.

Thread 450 uses read commands to read pages of data into cache 403. One page is read per slot in cache 403. Thread 450 modifies the data in one or more slots of the cache 403. Each page that is modified is marked as being dirty at that time. The dirty pages remain in cache 403 until more room is needed in cache 403 for a different page(s). At that time, one or more pages in cache 403 are evicted from the cache 403. If the evicted page is dirty, then thread 450 enters a write command in the submission queue 405 to write the page of data to memory sub-system 308. Writes to memory sub-system 308 of pages in cache 403 are only done when evicting a dirty page.

In one example, when controller 350 executes a read command 282, a backend application-specific circuit (not shown) reads at least a portion of user data 417 and corresponding ECC data 419 from stored data block 415. Error correction circuitry (not shown) is used to correct any errors found in the read data.

In one example, when controller 350 executes a write command 282, the backend application-specific circuit programs memory cells of memory cell array 413 to store user data 417 transferred from memory 304 (e.g., DRAM) of host system 302. The error correction circuitry generates ECC data 419 for the user data 417 to be written. The memory cells are programmed so that states of the memory cells correspond to the user data 417 and ECC data 419 to be stored as part of executing write command 282.

In one example, in response to a read command 282, a backend application-specific circuit reads user data 417 using operations defined by parameters that identify an LBA address of a logical block from which data is to be read. A flash translation layer converts the LBA address into a physical address in non-volatile memory cell array 413. The corrected user data 417 is transferred to memory 304 using direct memory access engine (DMA) 411. For example, user data 417 is transferred to a memory address of memory 304 provided by a data pointer field of read command 282.

In response to a write command 282, the backend application-specific circuit writes user data 417 using operations defined by parameters that identify an LBA address of a logical block in which data is to be written. A flash translation layer converts LBA address into a physical address in non-volatile memory cell array 413. The user data 417 to be written is transferred from memory 304 using direct memory access engine (DMA) 411. For example, user data 417 is transferred from a memory address of memory 304 provided by a data pointer field of write command 282.

In one embodiment, doorbell register 284 has a size of 4 bytes. Doorbell register 284 is defined as a range in a PCIe BAR address space.

In one embodiment, multiple commands 282 in a single batch are retrieved from submission queue 405 using a single PCIe read request. This can improve efficiency of PCIe bus usage. Controller 350 reads two or more commands 282 from submission queue 405 with one PCIe read request, instead of issuing a PCIe read request for each individual command. Commands 282 that are located at contiguous addresses in submission queue 405 can be coalesced into a single TLP 307. In one example, all commands in a batch are coalesced into a single TLP.

In one embodiment, commands 282 are processed by memory sub-system 308 in the same way as for commands according to a current version of the NVMe standard.

In one embodiment, threads 450 are executing in host system 302. Processing device 441 includes one or more cores (not shown). Each core executes one or more threads 450. Threads 450 are executed, for example, during training of one or more neural networks. During the training of the neural networks, various weights used in the training can be stored in memory sub-system 308 in response to write commands written by one or more threads 450 to one or more slots of submission queue 405. The weights can also be read from memory sub-system 308 in response to read commands sent by one or more threads 450 to one or more slots of submission queue 405.

In one example, many threads 450 execute in parallel during training of a neural network. Each thread 450 can perform an IO at the same time by each thread 450 using a different slot of submission queue 405.

When command 282 is retrieved from submission queue 405, command 282 includes an initial value for a phase bit. After execution, controller 350 generates completion record 290. Completion record 290 includes a final value for the phase bit. The final value indicates a status of the execution.

In one example, when the command 282 is retrieved, the phase bit includes an initial value based on stored content. When controller 350 generates and writes completion record 290, controller 350 inverts the initial value of the phase bit to provide the final value of the phase bit. This permits host system 302 to determine that the content in the completion record 290 is new, updated, and/or valid. An advantage of using the phase bit is that the host system 302 does not need to immediately process the completion record when controller 350 writes it to completion queue 407.

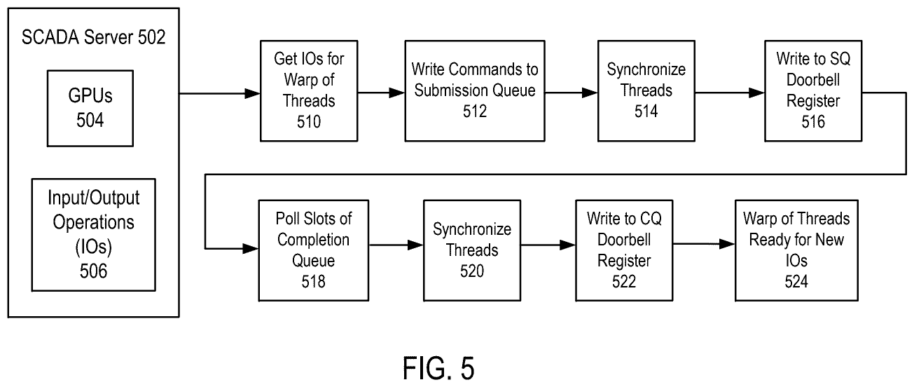

FIG. 5 shows a method for batch processing of commands for input/output operations (IOs) using threads from a same warp according to one embodiment. The method of FIG. 5 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 5 is performed at least in part by the processing device 118 of the host system 102, the controller 115 of the memory sub-system 101, and/or the local media controller 105 of the memory sub-system 101 in FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 5 can be implemented using the command batching manager 113 of FIG. 1 to perform the operations illustrated in FIGS. 2-4.

SCADA server 502 includes GPUs 504. GPUs 504 make requests for various input/output operations (IOs) 506. For example, the IOs come from a network and arrive on SCADA server 502. Various SSDs are connected to SCADA server 502.

At block 510 in FIG. 5, threads running on server 502 are controlled by SCADA software executing on server 502. A batch of IOs is selected by the SCADA software. The IOs will be processed in a batch using threads from a single warp. In one example, 32 threads are used.

At block 512, each thread writes a command to a submission queue. The commands are written in parallel. The size of the submission queue is the number of threads in the batch/warp. The commands can be written in parallel without the need for synchronization with any other thread running on the GPU because only this single warp is going to access the submission queue. Various lane numbers are assigned in the warp. The lane number gives the number of the thread. Each thread has its own assigned slot in the submission queue.

At block 514, execution of all threads is synchronized. For example, all threads must complete writing of a command to the submission queue before any thread can proceed with further processing. In one example, this synchronization is done using a syncwarp instruction (a GPU primitive) of GPUs 504 that is applied to all threads in the warp.

At block 516, after all threads have completed writing of the respective command to the submission queue, one of the threads writes a value to a submission queue doorbell register of an SSD (e.g., 230). The value is the number of commands that have been written. In one example, the value is 32.

In response to the value being written to the submission queue doorbell register, a solid-state drive retrieves all the commands in the batch written to the submission queue. The SSD then executes all commands.

At step 518, each thread in the single warp polls one of the slots of a completion queue to determine if a completion has been obtained. The slot of the completion queue that is polled is the slot identified by the index corresponding to the command. The index can be the lane number (of the thread in the warp that generated the command) or the command identifier (ID). The command identifier is set to the lane number (e.g., an integer between 0 and 31).

When a group of threads (e.g., 32 threads) starts using a QP, each thread is assigned an index (e.g., from 0 to 31). Depending on the approach, the threads are all of a same warp, or the threads are from different warps. This index is used by a thread to know the slot/entry of the SQ to use (SQ[index]), to know the slot/entry to poll in the CQ (CQ[index]), and to provide the value for the command identifier that is placed in the command (e.g., an NVMe command). For the first approach (threads of same warp), the index is the “lane number”, which is the number of the thread in its warp. For the second approach, the index is computed as the ticket number modulo 32.

At step 520, execution of all threads is synchronized. For example, this synchronization is done using a syncwarp instruction (a GPU primitive) of GPUs 504 that is applied to all threads in the warp. The instruction is applied to each thread and requires that all threads in the warp have obtained a completion prior to any thread proceeding with further processing.

At step 522, after all threads have completed obtaining a completion from the completion queue, then a value is written to a completion queue doorbell register. In one example, the value is the number of completion records that have been consumed by the host system (e.g., in accordance with the NVMe specification/standard. For example, the value is 32.

At block 524, after the value is written to the completion queue doorbell register, the threads are ready for performing new IOs. SCADA software on server 502 selects a batch of new IOs to be handled by the threads of the warp.

In one embodiment, an index (e.g., lane number of the thread in its warp (an integer from 0 to 31)) is assigned to each thread doing an IO that is running on a graphics processing unit (GPU) 504. The index ranges from 0 to the number of threads in a warp/batch size/QP size (e.g. 31). By assigning each thread to a different index, thread contention for access to the queue pair is avoided. Only one thread is assigned to each available index of the submission queue at any given time. The command identifier (ID) can be simply set to the index or lane number.

For example, index 3 is assigned to a thread. The thread generates a command that is stored in slot 3 of the submission queue. A controller of a memory sub-system retrieves the command from the submission queue when all commands in a batch are retrieved. After executing the command, the controller writes a completion record to the completion queue. The order of completion records written to the completion queue can be different from the ordering of corresponding commands in the submission queue.

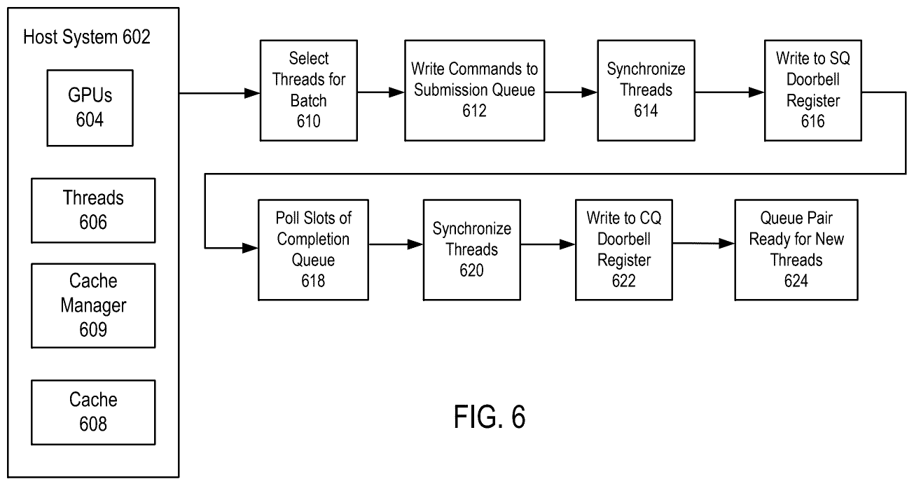

FIG. 6 shows a method for batch processing of commands for threads from different warps according to one embodiment. The method of FIG. 6 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 6 is performed at least in part by the processing device 118 of the host system 102, the controller 115 of the memory sub-system 101, and/or the local media controller 105 of the memory sub-system 101 in FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 6 can be implemented using the command batching manager 113 of FIG. 1 to perform the operations illustrated in FIGS. 2-4.

Host system 602 includes GPU 604. Threads 606 run on GPUs 604. Some of threads 606 execute commands to read pages of data into cache 608.

In one embodiment, cache 608 is a software cache implemented in host memory. Cache manager 609 is software that manages cache 608. Cache 608 is an example of cache 403.

At block 610 in FIG. 6, a batch of threads is selected from different warps. The warps are assigned to a same streaming multiprocessor (e.g., SM 204). Atomic variables will be used to identify and synchronize the threads because they are from different warps. These atomic variables include a variable for a ticket, a variable for a number of commands in the submission queue, and a variable for a number of completions in the completion queue.

Each thread obtains a ticket. The ticket is an integer that is incremented as each thread obtains its ticket. For example, tickets 0-31 use a first queue pair, tickets 32-63 use a second queue pair, etc.

A command identifier is determined for each thread using the ticket. The command identifier is computed as the ticket number modulo (number of queue pair entries). The command identifier identifies the command. The command identifier also is an index that identifies a position of the command in the submission queue and the slot of the CQ that will be polled by the thread.

At block 612, each thread writes a command to a submission queue of a queue pair. As each thread writes its command, the atomic variable for number of commands in the submission queue is incremented. The threads write commands to the submission queue in parallel.

At block 614, all threads are synchronized. As each thread writes its command in the submission queue, the thread also determines whether the atomic variable for number of commands has reached a value that corresponds to the size of the batch. For example, the last thread to write its command determines that the number of commands has reached 32, indicating that all commands have been written. The other threads also determine that the number of commands has reached 32. At this point, each thread can proceed with further processing.

At block 616, after all threads have written commands to the submission queue, a value is written to a submission queue doorbell register. For example, the value can be written by the thread that determines that the number of commands written to the submission queue has reached 32.

At block 618, each thread polls the slot CQ[command identifier] of a completion queue of the queue pair. In one example, each thread polls the slot that corresponds to the command identifier

At block 620, all threads are synchronized. Each thread increments the atomic variable for number of completions in the completion queue as its slot in the completion queue is polled. This polling by the threads is done in parallel. Each thread makes a determination whether the atomic variable for number of completions has reached the number of slots (e.g., 32 slots) in the completion queue. Because the completions may arrive in a different order than the ordering of commands retrieved by the SSD, only the number of completions is counted. There is no need to match a command to a command identifier in a completion record.

At block 622, after all threads have obtained a completion from the completion queue, a value is written to a completion queue doorbell register. For example, the thread that detects the last completion (based on the number of completions atomic variable) writes a value in a completion queue doorbell register. The value corresponds to the number of entries (e.g., 32) in the completion queue.

At block 624, after the value is written to the completion queue doorbell register, the queue pair is ready for use with a new batch of threads. For example, the thread that detects the last completion increments serving of the queue pair for another batch of threads.

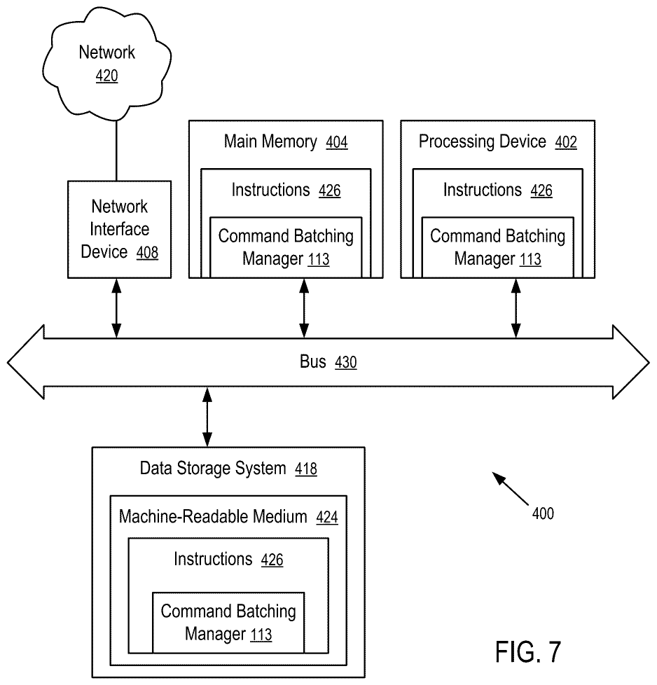

FIG. 7 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of command batching manager 113 (e.g., to execute instructions to perform operations corresponding to the command batching manager 113 described with reference to FIGS. 1-6). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

In one example, instructions 426 are executed to configure processing of commands. In one example, instructions 426 are executed to configure firmware and/or hardware circuitry.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the command batching manager 113 described with reference to FIGS. 1-6. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A host system comprising:
memory; and
at least one processing device configured to:
allocate a portion of the memory for a queue pair; and
batch submitting of commands for processing by a memory sub-system via the queue pair.

2. The host system of claim 1, wherein the queue pair comprises a submission queue and a completion queue.

3. The host system of claim 1, wherein batching the submitting of commands comprises synchronizing threads using the queue pair for input/output operations.

4. The host system of claim 1, wherein the processing device is a graphics processing unit running threads that write the commands to a submission queue of the queue pair.

5. The host system of claim 1, wherein batching the submitting of commands comprises writing to a submission queue doorbell register of the memory sub-system in response to determining that a batch of threads has completed writing the commands to a submission queue.

6. The host system of claim 5, wherein the processing device is further configured to write to a completion queue doorbell register of the memory sub-system in response to determining that the batch of threads has completed obtaining completion records from a completion queue.

7. A host system comprising:
memory; and
at least one processing device comprising a plurality of streaming multiprocessors, wherein:
each streaming multiprocessor is configured to use a respective plurality of submission queues; and
the processing device is configured to, for each submission queue, submit commands for processing by a memory sub-system in response to determining that a first batch of the commands has been written to the submission queue.

8. The host system of claim 7, wherein a plurality of threads running on the each streaming multiprocessor are configured to write the commands into the respective plurality of submission queues.

9. The host system of claim 7, wherein the processing device is a graphics processing unit (GPU).

10. The host system of claim 7, wherein the host system is configured to write to a doorbell register of the memory sub-system to cause the memory sub-system to retrieve the commands for execution in the memory sub-system.

11. The host system of claim 7, further comprising a respective completion queue for each submission queue, wherein the processing device is further configured to, for each completion queue, write to a doorbell register of the memory sub-system in response to obtaining a second batch of completion records from the completion queue.

12. The host system of claim 11, wherein the host system is further configured to cause the memory sub-system to service one submission queue for each of the plurality of streaming multiprocessors in a round-robin scheme and service the respective plurality of submission queues for the each streaming multiprocessor in a round-robin scheme.

13. The host system of claim 7, wherein the processing device is further configured to manage a software cache to implement an array abstraction in the memory, and each command causes writing by the memory sub-system of a page of data into the software cache when the command is executed by the memory sub-system.

14. (canceled)

15. (canceled)

16. (canceled)

17. (canceled)

18. (canceled)

19. (canceled)

20. (canceled)

21. A host system comprising:
memory; and
at least one processing device comprising a plurality of streaming multiprocessors, wherein:
each streaming multiprocessor is configured to use a respective plurality of queue pairs; and
the processing device is configured to, for each queue pair, assign threads executing on a streaming multiprocessor to one of the queue pairs.

22. The host system of claim 21, wherein a plurality of threads running on each streaming multiprocessor are configured to write commands into a respective plurality of submission queues.

23. The host system of claim 21, wherein each queue pair comprises a submission queue and a completion queue.

24. The host system of claim 23, wherein the processing device is further configured to, for each queue pair, allocate the queue pair in the memory.

25. The host system of claim 21, wherein the processing device is further configured to, for each queue pair, cause the assigned threads to write commands into different slots of a submission queue of the assigned queue pair.

26. The host system of claim 21, wherein the processing device is further configured to, for each queue pair, determine that a first batch of commands has been written to a submission queue, and in response write a value to a corresponding submission queue doorbell register of a memory sub-system.

27. The host system of claim 26, wherein writing the value to the corresponding submission queue doorbell register causes the memory sub-system to retrieve the first batch of commands from the submission queue.
